(19) United States
(12) Patent Application Publication
(10) Pub. No.: US 2026/0099323 A1
(43) Pub. Date: Apr. 9, 2026

(54) CONFLICT MANAGEMENT FOR QUANTUM VERSION CONTROLLED FILES

(71) Applicant: Red Hat, Inc., Raleigh, NC (US)

(72) Inventors: Leigh Griffin, Waterford (IE); Pierre-Yves Chibon, Puteaux (FR)

(21) Appl. No.: 18/905,857

(22) Filed: Oct. 3, 2024

(51) Int. Cl. G06F 8/71

(52) U.S. Cl. CPC G06F 8/71

(57) ABSTRACT

Techniques for resolving qubit usage conflicts arising from different versions of a quantum file are disclosed. A first qubit having original data associated with a first version of a quantum file may be modified to store first modified data associated with a second version of the quantum file. In response to receiving a request to modify the first qubit with second modified data associated with a proposed third version of the quantum file, a set of auxiliary qubits is allocated. The original data, the first modified data and the second modified data are stored in respective auxiliary qubits and a version conflict file referencing the respective auxiliary qubits is generated. When a request to access a current version of the quantum file is received, the version conflict file is returned allowing for creation of any of the first, second or third versions of the quantum file on an ad-hoc basis.

### TECHNICAL FIELD

Aspects of the present disclosure relate to resolution of conflicts between different versions of quantum files, and in particular to resolution of qubit usage conflicts arising from different versions of a quantum file.

### BACKGROUND

Quantum computing is a type of computation that harnesses the collective properties of quantum states, such as superposition, interference, and entanglement, to perform calculations. The devices that perform quantum computations are known as quantum computers. Although there are different types of quantum computers, one of the most widely used is the quantum circuit, based on the quantum bit (also referred to as a “qubit”). A qubit can be in a 1 or 0 quantum state, or in a superposition of the 1 and 0 states. When it is measured, however, it is always 0 or 1 and the probability of either outcome depends on the qubit's quantum state immediately prior to measurement. Using non-quantum hardware, a search problem with a search space of N items requires examination of the search space on the order of N times to find the item being sought. However, quantum hardware may solve the search problem after examining the search space approximately √N times. Although classical cluster management services can discover classical machines/computing devices and create clusters using classical hardware, they are unable to support creation of clusters that use quantum hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for resolving qubit usage conflicts arising from different versions of a quantum file, in accordance with some embodiments of the present disclosure.

FIG. 2A is a block diagram that illustrates the example system of FIG. 1, while generating a version conflict file, in accordance with some embodiments of the present disclosure.

FIG. 2B is a block diagram that illustrates the example system of FIG. 1, while performing operations associated with resolving qubit usage conflicts arising from different versions of a quantum file, in accordance with some embodiments of the present disclosure.

FIG. 3 is a diagram that illustrates tree structure representations of the version conflict file of FIG. 2A, in accordance with some embodiments of the present disclosure.

FIG. 4 is a flow diagram of a method for resolving qubit usage conflicts arising from different versions of a quantum file, in accordance with some embodiments of the present disclosure.

FIG. 5 is a block diagram of an example computing device that may perform one or more of the operations described herein, in accordance with some embodiments of the present disclosure.

### DETAILED DESCRIPTION

Qubits are fragile resources and in a shared environment where multiple entities must share the same finite pool of qubits, effective management and gating of qubit access is important to maintain a system that can run quantum services efficiently. Because multiple entities cannot access the same qubit at the same time without causing decoherence, and because there is a finite number of qubits in any quantum computer, there will often be conflicts on the usage of the qubits in the quantum computer. To address this, quantum computers often utilize a concept referred to as “recycling” where a qubit can be reused by multiple entities in succession. For example, a first entity may access a qubit and perform work involving writing data to the qubit. After the first entity releases its lock on the qubit, a second entity may access the qubit and perform work which results in different data being written to the qubit. If subsequently the first entity returns to continue its work, the information it had originally written to the qubit is no longer available. This makes it difficult to perform long running operations where data written to a qubit by an entity must be available even after the entity has released its lock on the qubit.

The present disclosure addresses the above-noted and other deficiencies by providing techniques for resolving qubit usage conflicts arising from different versions of a quantum file. A first entity may modify a first qubit having original data associated with a first version of a quantum file. As a result of the modification, the first qubit stores first modified data associated with a second version of the quantum file. In response to receiving a request from a second entity to modify the first qubit with second modified data associated with a proposed third version of the quantum file, a set of auxiliary qubits (each of which is empty) is allocated. The original data, the first modified data and the second modified data are stored in a first auxiliary qubit, a second auxiliary qubit and a third auxiliary qubit of the set of auxiliary qubits respectively. A version conflict file that references each of the first auxiliary qubit, the second auxiliary qubit and the third auxiliary qubit is generated. In response to receiving a request to access a current version of the quantum file, the version conflict file is returned to allow for creation of any of the first, second or third versions of the quantum file on an ad-hoc basis without interfering with other versions of the quantum file.

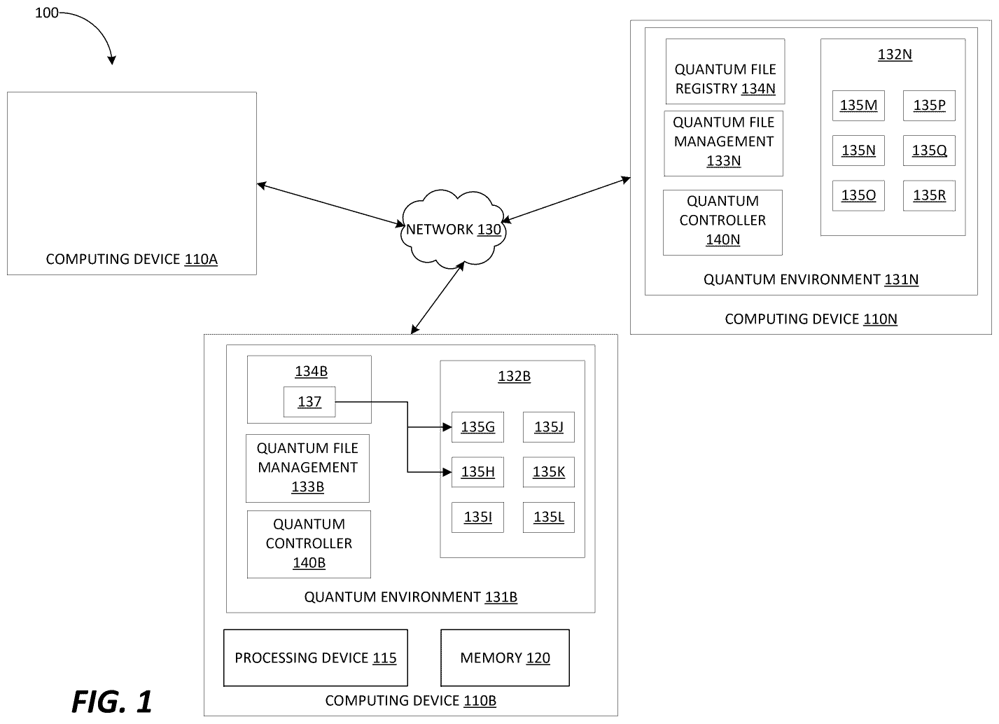

FIG. 1 is a block diagram that illustrates an example system 100. As illustrated in FIG. 1, the system 100 includes computing devices 110A-110N, and a network 130. The computing devices 110 may be coupled to each other (e.g., may be operatively coupled, communicatively coupled, may communicate data/messages with each other) via network 130. Network 130 may be a public network (e.g., the internet), a private network (e.g., a local area network (LAN) or wide area network (WAN)), or a combination thereof. In one embodiment, network 130 may include a wired or a wireless infrastructure, which may be provided by one or more wireless communications systems, such as a WiFi™ hotspot connected with the network 130 and/or a wireless carrier system that can be implemented using various data processing equipment, communication towers (e.g., cell towers), etc. The network 130 may carry communications (e.g., data, message, packets, frames, etc.) between computing devices 110.

Each of the computing devices 110 may include hardware such as processing device 115 (e.g., processors, central processing units (CPUs), memory 120 (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

FIG. 1 and the other figures may use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

Each of the computing devices 110 may comprise any suitable type of computing device or machine that has a programmable processor including, for example, server computers, desktop computers, laptop computers, tablet computers, smartphones, set-top boxes, etc. In some examples, the computing devices 110 may comprise a single machine or may include multiple interconnected machines (e.g., multiple servers configured in a cluster). The computing devices 110 may be implemented by a common entity/organization or may be implemented by different entities/organizations. For example, computing device 110A may be operated by a first company/corporation and computing device 110B may be operated by a second company/corporation. The computing devices 110 may each execute or include an operating system (OS), as discussed in more detail below. The OSs of each computing device 110 may manage the execution of other components (e.g., software, applications, etc.) and/or may manage access to the hardware (e.g., processors, memory, storage devices etc.) of their respective computing device.

In some embodiments, each of the computing devices 110 may comprise a quantum computing system. The computing devices 110 may be close in physical proximity to one another, or may be relatively long distances from one another, such as hundreds or thousands of miles from one another. The computing devices 110 may operate in quantum environments but can operate using classical computing principles or quantum computing principles. When using quantum computing principles, the computing devices 110 perform computations that utilize quantum mechanical phenomena, such as superposition and entanglement. The computing devices 110 may operate under certain environmental conditions, such as at or near 0° Kelvin.

As shown in FIG. 1, each computing device 110 may include a respective quantum environment 131 that includes a quantum controller 140, a qubit registry 132 and a plurality of qubits 135. The quantum controller 140 may be any appropriate quantum computing device as described hereinabove. Operations may be performed using quantum files, which may comprise information that is stored across a subset of the qubits 135.

Each quantum environment 131 includes a quantum file management system 133 and a quantum file registry 134. Each quantum file management system 133 may operate to implement quantum files on the respective quantum environment 131 and each quantum file registry 134 may include a plurality of quantum file records (not shown), each of which corresponds to a quantum file implemented in the quantum environment 131. Each quantum file record may include metadata regarding the corresponding quantum file, such as an internal identifier field that identifies an internal file identifier of the quantum file, a size field that identifies the number of qubits 135 that make up the quantum file, and for each qubit 135 of the number of qubits 135 that make up the quantum file, a qubit identification field and an entanglement status field.

As shown in FIG. 1, a quantum file 137 has been implemented on the quantum environment 131B. The information of the quantum file 137 may be stored across two qubits 135: qubit 135G and a qubit 135H, both hosted on the quantum environment 131B. Although described as both qubit 135G and a qubit 135H being hosted on the quantum environment 131B, this is not a limitation and each qubit 135 that forms a quantum file may be hosted on different quantum environments 131/different computing devices 110.

The quantum environment 131B also includes a file system (not shown) that includes one or more quantum file references, where each quantum file reference corresponds to a quantum file record maintained in the quantum file registry 134B, and that is “owned” by the computing device 110B. The quantum file 137 is accessed by a requestor via its corresponding quantum file reference, and the corresponding quantum file reference is identified by the requestor via a quantum file identifier (not shown).

When a requestor of a quantum file (e.g., a quantum application - not shown) seeks access to the quantum file 137, it may provide the quantum file identifier corresponding to the quantum file reference of quantum file 137 to the quantum file management system 133B. The requestor may interface with the quantum management system 133B via any suitable inter-process communications mechanism, such as an application programming interface (API) or the like. In some embodiments, the quantum management system 133B may be an integral part of a quantum operating system, and the appropriate intercommunication mechanisms between the quantum application (the requestor in this example) and the quantum management system 133B may be generated in response to certain programming instructions, such as reading, writing, or otherwise accessing the quantum file 137 while the quantum application is being compiled.

The quantum file management system 133B accesses the file system. More specifically, based on the quantum file identifier, the quantum file management system 133B accesses the quantum file reference, which includes metadata about the quantum file 137. The quantum file reference may include metadata fields in which the metadata about the quantum file 137 is stored. The metadata may include information about the quantum file 137, such as a creation timestamp of the quantum file137, a last modification timestamp of the quantum file 137, a current user of the quantum file 137, and the like. The quantum file reference identifies each qubit that makes up the quantum file 137, in this example the qubits 135G and 135H. The qubits 135G and 135H may be identified in any desired manner. In some examples, a qubit identifier includes information that identifies the particular quantum environment 131 on which the qubit 135 is located and a qubit reference number that uniquely corresponds to the particular qubit 135 on the identified quantum environment 131.

In some embodiments, data of the quantum file 137 may be spread over the qubits 135G and 135H in a manner that dictates that the qubits 135G and 135H must be accessed in some sequential order for the data to have contextual meaning. The order in which the qubits 135G and 135H are identified in the quantum file reference may correspond to the appropriate order in which the qubits 135G and 135H should be accessed. In other examples, the quantum file reference may have an additional field identifying the appropriate order.

The quantum file reference may also include a qubit entanglement status field that maintains entanglement status information about the qubits 135G and 135H. For example, the qubit entanglement status field may indicate that, at the time of the last update of the quantum file reference, the qubit 135G was not in an entangled state with any other qubit. The quantum file management system 133B may update the quantum file reference with the information from the quantum file record and the outcome of any checks (e.g., entanglement checks), and then give control to the quantum application, passing the quantum application at least some of the updated information contained in the quantum file reference such as the first qubit identifier field and the second qubit identifier field, and the qubit status information contained in the qubit entanglement status fields. The quantum application may then initiate actions against the qubits 135G and 135H such as read actions, write actions, or the like.

As discussed herein, the quantum file 137 may be accessed for use by a first entity (also referred to herein as a “requestor”) which, upon completing its work may relinquish its lock on the qubits 135G And 135H. Subsequently, the quantum file 137 may be accessed for use by a second entity (second requestor) which may complete its work, resulting in the data that was written to qubit 135G as a result of the work done by the first entity no longer being available. If the first entity subsequently wishes to continue the work it was performing, it can no longer do so because the data that it wrote to qubit 135G is no longer available.

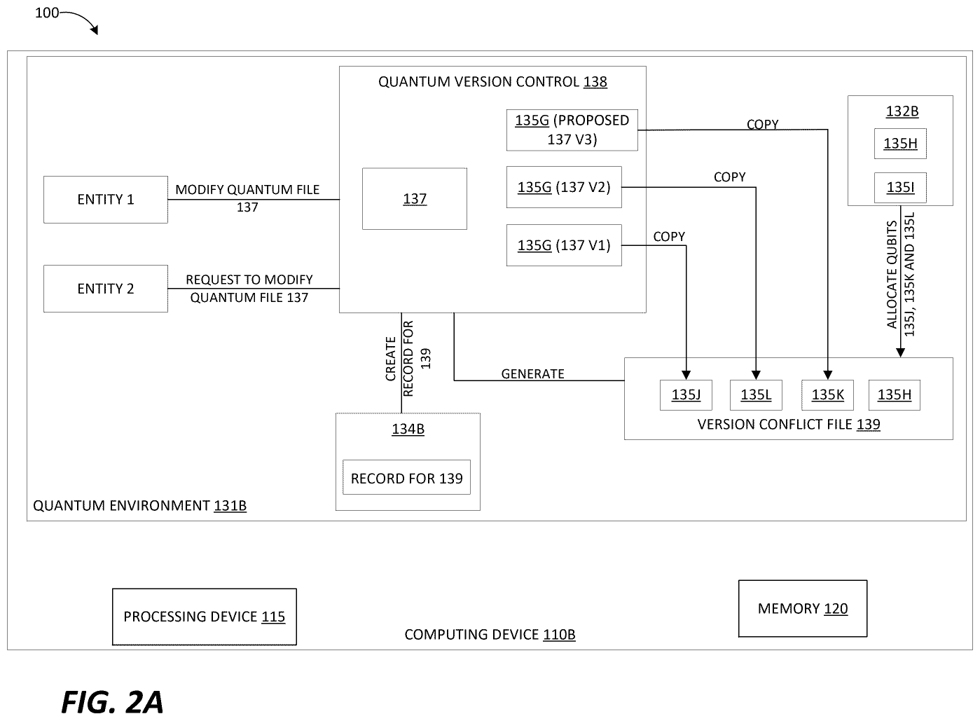

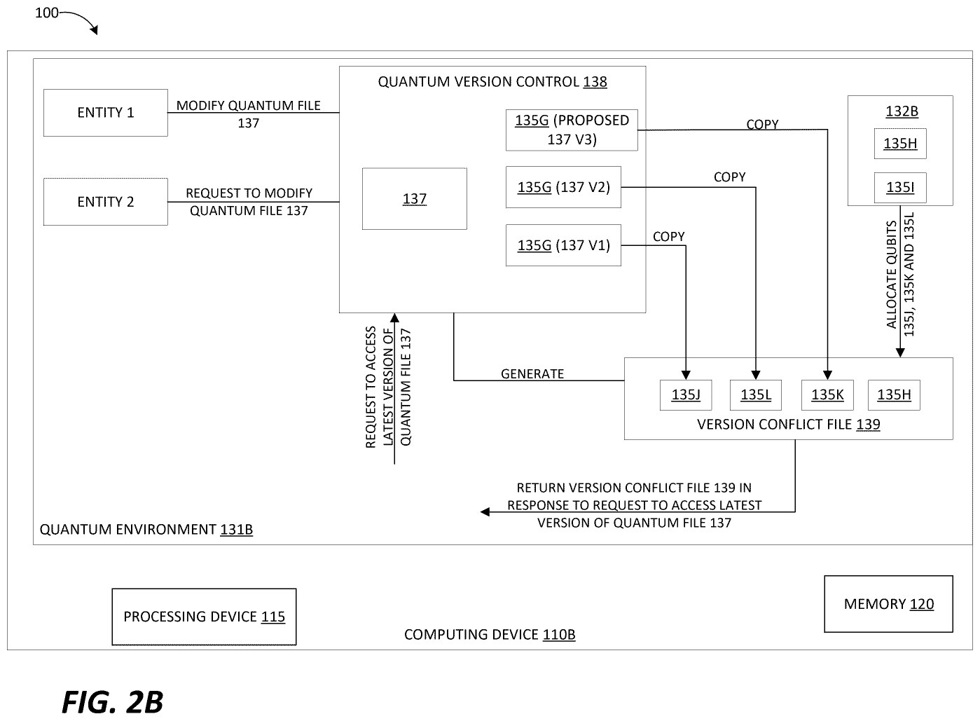

FIG. 2 illustrates the system 100 implementing a quantum version control (QVC) service 138 that addresses such conflicts in accordance with some embodiments of the present disclosure. In the example of FIG. 2, the quantum file 137 may currently be denoted by the QVC service 138 as version 1, and the corresponding qubits 135G and 135H may each have certain data stored therein (also referred to herein as original data) corresponding to version 1 of the quantum file 137. Version 1 of the quantum file 137 may be accessed for use by a first entity that wishes to perform certain work (e.g., read actions, write actions, or the like) on the quantum file 137 (i.e., the qubits 135G and 135H). The first entity may complete its work on the quantum file 137 and the QVC service 138 may increment the version number of the quantum file 137 to version 2. The qubit 135G may now store modified data corresponding to version 2 of the quantum file 137. Subsequently, a second entity may request access to the quantum file 137 to perform certain work, including writing over some or all of the modified data corresponding to version 2 of the quantum file 137. As a result of the second entity's proposed changes, the qubit 135G would store second modified data associated with a proposed version 3 of the quantum file 137. In response to this request by the second entity, the QVC service 138 may initiate its conflict resolution process.

More specifically, the QVC service 138 may identify the qubits 135 that have a conflict between versions of the quantum file 137. In the example of FIG. 2, qubit 135G may have a conflict, as the work of the second entity may overwrite data that was written during the work of the first entity to qubit 135G. The work of the second entity may not overwrite any data that was written by the write processes of the first entity to qubit 135H and thus qubit 135H may not have a conflict. The QVC service 138 may then request from the qubit registry 132B, a number of empty qubits 135 that is equal to three times the number of qubits that have a conflict. In the example of FIG. 2, the QVC service 138 may request three empty qubits 135 as only qubit 135G is in conflict. Thus, the qubit registry 132B may provide empty qubits 135J, 135K and 135L (also referred to herein as “auxiliary qubits 135”). The QVC service 138 may place the original data stored in qubit 135G (corresponding to version 1 of the quantum file 137) into qubit 135J, and may place the modified data stored in the qubit 135G from version 2 of the quantum file 137 into qubit 135K. The QVC service 138 may place the changes to qubit 135G proposed by the second entity's requested work (i.e., the second modified data corresponding to the proposed version 3 of the quantum file 137) into qubit 135L.

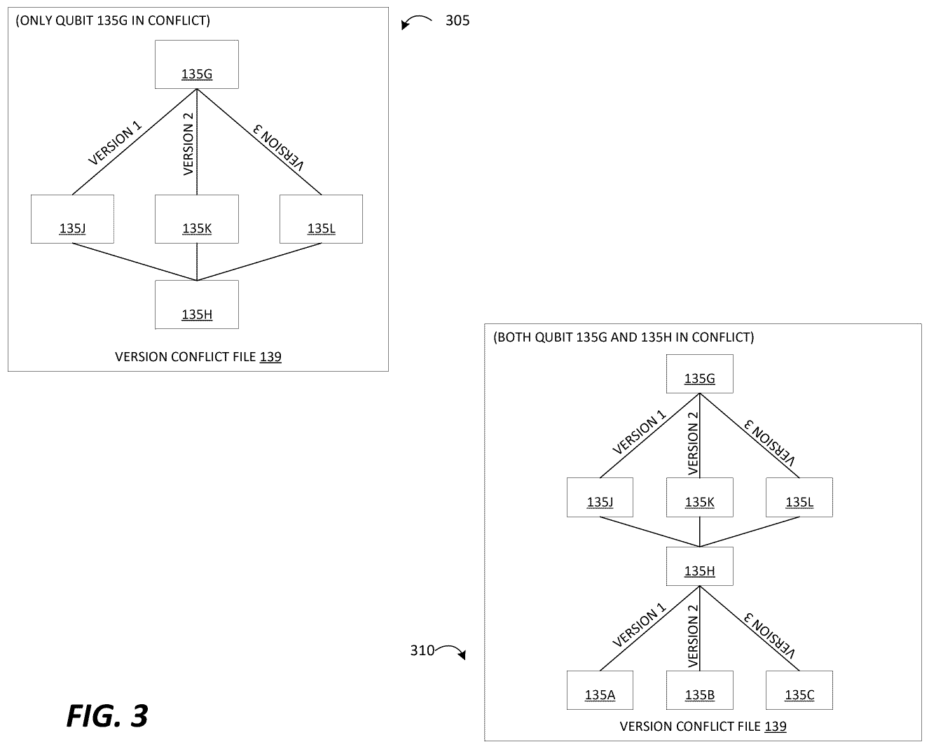

The QVC service 138 may create a version conflict file 139 which may be a version of the quantum file 137 that has no conflicted qubits 135 because it includes a pointer to the data stored on the qubit 135G for each version of the quantum file 137. FIG. 3 illustrates tree graph views 305 and 310 of the version conflict file 139 for two scenarios respectively: a first scenario (305) where only the qubit 135G is in conflict and a second scenario (310) where both the qubits 135G and 135H are in conflict. As shown in FIG. 3 for tree graph view 305, when only the qubit 135G is in conflict the entry for qubit 135G includes multiple branches, each branch pointing to a qubit 135 that includes data stored on the qubit 135G by a corresponding version of the quantum file 137 (i.e., qubits 135J, 135K and 135L). Stated differently, each branch points to changes made to the qubit 135G by a different version of the quantum file 137. Because the qubit 135H is not in conflict in this example, it is included in the version conflict file 139 as is (i.e., the entry for the qubit 135H has no branches) and each branch for the entry for qubit 135G may lead to the entry for the qubit 135H. The QCV service 138 may also create a record for the version conflict file 139 in the quantum file registry 134B.

Until a resolution process (i.e., a process to resolve the conflict between versions of the quantum file 137) occurs, when an entity wants to access the current version of the quantum file 137, the QVC service 138 may provide the version conflict file 139 to the requesting entity, thereby providing the requesting entity with all of the different potential resolution pathways (e.g., qubit 135J and qubit 135H; qubit 135K and qubit 135H; qubit 135L and qubit 135H). More specifically, the version conflict file 139 is retrieved and the qubits 135J, 135K and 135L are placed into superposition. Through the use of biasing, the requesting entity may be able to select which version of the quantum file 137 they want to use by biasing the qubit 135J, 135K or 135L corresponding to the version of the quantum file 137 (i.e., version 1, 2 or 3) they want to use. In this way, if the first entity subsequently returns and wants to continue their work, when presented with the version conflict file 139 they can create their version of the quantum file 137 (version 2 in this case) in an ad hoc manner without interfering with the data corresponding to version 3 of the quantum file 137 by selecting the resolution pathway including qubit 135K and qubit 135H. Alternatively, the requesting entity (using biasing) may generate new variants of the quantum file 137 that can accommodate changes from multiple versions of the quantum file 137 by algorithmically influencing the superposition result.

During a resolution process, the QVC service 138 may provide the version conflict file 139 to a client, thereby providing the client with all of the different potential resolution pathways (e.g., qubit 135J and qubit 135H; qubit 135K and qubit 135H; qubit 135L and qubit 135H). The client may identify which version of the quantum file 137 they want to preserve as the authoritative version (e.g., version 1 (implemented with qubit 135J and qubit 135H), version 2 (implemented with qubit 135K and qubit 135H) or proposed version 3 (implemented with qubit 135L and qubit 135H)). For example, the client may determine that they want proposed version 3 of the quantum file 137 to be the authoritative version and that they do not want the changes made by the first entity (version 2 ) to take effect. Thus, the QVC service 138 may discard qubits 135J and 135K and generate version 3 of the quantum file 137, where the version 3 of the quantum file 137 references qubit 135L (which includes the changes to qubit 135G proposed by the second entity's requested work) and qubit 135H.

Alternatively, the client may determine that all three versions of the quantum file 137 should be preserved (i.e., all of the resolution pathways are valid). If the client determines that all three versions of the quantum file 137 should be preserved, the QVC service 138 may maintain its lock on the qubits 135J, 135K and 135L and generate version 3 of the quantum file 137 that references qubits 135L (which includes the changes proposed by the second entity's work) and 135H. In this way, if the first entity subsequently returns and wants to continue their work, when presented with the version conflict file 139 they can create their version of the quantum file 137 (version 2 in this case) in an ad hoc manner by selecting the resolution pathway including qubit 135K and qubit 135H.

The use of biasing also allows the client to generate new variants of the quantum file 137 that can accommodate changes from multiple versions by algorithmically influencing the superposition result. Thus, the client may also generate a new version of the quantum file 137 that includes changes from multiple versions of the quantum file 137 and identify the new version of the quantum file 137 as the authoritative version.

In some embodiments, the QVC service 138 may implement the version conflict file 139 with the entry for qubit 135G pointing only to qubits 135J and 135K (i.e., the data stored in qubit 135G for versions 1 and 2 of the quantum file 137). The QVC service 138 may generate a version 3 of the quantum file 137 with qubit 135L (including the changes to qubit 135G proposed by the second entity's requested work) that includes a reference to the version conflict file 139. In this way, when the client requests the current version of the quantum file 137, version 3 is returned and the version conflict file 139 is retrieved and placed into superposition along with version 3 of the quantum file 137. The entity is given a biasing option to choose version 1, 2 or 3 of the quantum file 137 or a combination thereof by algorithmically influencing the superposition result as discussed hereinabove.

FIG. 3 also illustrates a tree graph view 310 of a more complex example of the version conflict file 139 when both qubits 135G and 135H are in conflict. As shown in FIG. 3 for tree graph view 310, the entry for qubit 135G includes multiple branches, each pointing to a qubit 135 that includes data stored on the qubit 135G by a corresponding version of the quantum file 137 (i.e., qubits 135J, 135K and 135L). In addition, the entry for qubit 135H includes multiple branches, each pointing to a qubit 135 that includes data stored on the qubit 135H by a corresponding version of the quantum file 137 (i.e., qubits 135A, 135B and 135C). As can be seen, as additional qubits 135 of the quantum file 137 are in conflict, the number of resolution pathways branches exponentially.

Embodiments of the present disclosure provide a conflict resolution method that will not block or hinder quantum files that have conflicted qubits from being used even if a resolution process has not yet taken place. As a result, layered software such as middleware may be more efficiently implemented in quantum environments.

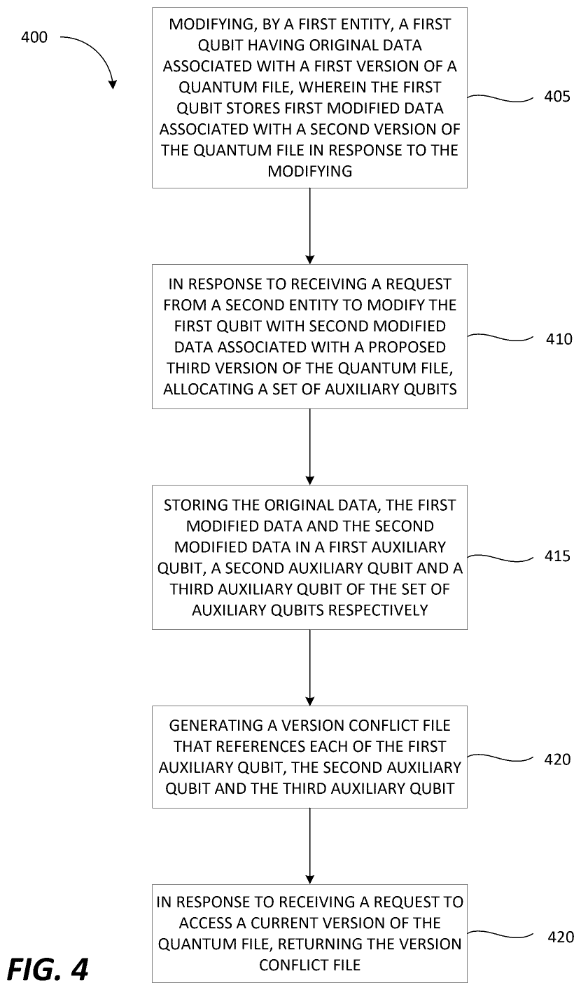

FIG. 4 is a flow diagram of a method 400 for resolving conflicts in quantum files, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device, e.g., computing device 110B illustrated in FIGS. 1 and 2.

Referring simultaneously to FIG. 2, at block 405, the quantum file 137 may currently be denoted by the QVC service 138 as version 1, and the corresponding qubits 135G and 135H may each have certain data stored therein (also referred to herein as original data) corresponding to version 1 of the quantum file 137. Version 1 of the quantum file 137 may be accessed for use by a first entity that wishes to perform certain work (e.g., read actions, write actions, or the like) on the quantum file 137 (i.e., the qubits 135G and 135H). The first entity may complete its work on the quantum file 137 and the QVC service 138 may increment the version number of the quantum file 137 to version 2. The qubit 135G may now store modified data corresponding to version 2 of the quantum file 137. Subsequently, a second entity may request access to the quantum file 137 to perform certain work, including writing over some or all of the modified data corresponding to version 2 of the quantum file 137. As a result of the second entity's proposed changes, the qubit 135G would store second modified data associated with a proposed version 3 of the quantum file 137. In response to this request by the second entity, the QVC service 138 may initiate its conflict resolution process.

The QVC service 138 may identify the qubits 135 that have a conflict between versions of the quantum file 137. In the example of FIG. 2, qubit 135G may have a conflict, as the work of the second entity may overwrite data that was written during the work of the first entity to qubit 135G. The work of the second entity may not overwrite any data that was written by the write processes of the first entity to qubit 135H and thus qubit 135H may not have a conflict. The QVC service 138 may then request from the qubit registry 132B, a number of empty qubits 135 that is equal to three times the number of qubits that have a conflict. The QVC service 138 may request three empty qubits 135 as only qubit 135G is in conflict. Thus, at block 410, the qubit registry 132B may provide empty qubits 135J, 135K and 135L (also referred to herein as “auxiliary qubits 135”). At block 415, the QVC service 138 may place the original data stored in qubit 135G (corresponding to version 1 of the quantum file 137) into qubit 135J, and may place the modified data stored in the qubit 135G from version 2 of the quantum file 137 into qubit 135K. The QVC service 138 may place the changes to qubit 135G proposed by the second entity's requested work (i.e., the second modified data corresponding to the proposed version 3 of the quantum file 137) into qubit 135L.

At block 420, the QVC service 138 may create a version conflict file 139 which may be a version of the quantum file 137 that has no conflicted qubits 135 because it includes a pointer to the data stored on the qubit 135G for each version of the quantum file 137. FIG. 3 illustrates tree graph views 305 and 310 of the version conflict file 139 for two scenarios respectively: a first scenario (305) where only the qubit 135G is in conflict and a second scenario (310) where both the qubits 135G and 135H are in conflict. As shown in FIG. 3 for tree graph view 305, when only the qubit 135G is in conflict the entry for qubit 135G includes multiple branches, each branch pointing to a qubit 135 that includes data stored on the qubit 135G by a corresponding version of the quantum file 137 (i.e., qubits 135J, 135K and 135L). Stated differently, each branch points to changes made to the qubit 135G by a different version of the quantum file 137. Because the qubit 135H is not in conflict in this example, it is included in the version conflict file 139 as is (i.e., the entry for the qubit 135H has no branches) and each branch for the entry for qubit 135G may lead to the entry for the qubit 135H. The QCV service 138 may also create a record for the version conflict file 139 in the quantum file registry 134B.

At block 425, until a resolution process (i.e., a process to resolve the conflict between versions of the quantum file 137) occurs, when an entity wants to access the current version of the quantum file 137, the QVC service 138 may provide the version conflict file 139 to the requesting entity, thereby providing the requesting entity with all of the different potential resolution pathways (e.g., qubit 135J and qubit 135H; qubit 135K and qubit 135H; qubit 135L and qubit 135H). More specifically, the version conflict file 139 is retrieved and the qubits 135J, 135K and 135L are placed into superposition. Through the use of biasing, the requesting entity may be able to select which version of the quantum file 137 they want to use by biasing the qubit 135J, 135K or 135L corresponding to the version of the quantum file 137 (i.e., version 1, 2 or 3) they want to use. In this way, if the first entity subsequently returns and wants to continue their work, when presented with the version conflict file 139 they can create their version of the quantum file 137 (version 2 in this case) in an ad hoc manner without interfering with the data corresponding to version 3 of the quantum file 137 by selecting the resolution pathway including qubit 135K and qubit 135H. Alternatively, the requesting entity (using biasing) may generate new variants of the quantum file 137 that can accommodate changes from multiple versions of the quantum file 137 by algorithmically influencing the superposition result.

During a resolution process, the QVC service 138 may provide the version conflict file 139 to a client, thereby providing the client with all of the different potential resolution pathways (e.g., qubit 135J and qubit 135H; qubit 135K and qubit 135H; qubit 135L and qubit 135H). The client may identify which version of the quantum file 137 they want to preserve as the authoritative version (e.g., version 1 (implemented with qubit 135J and qubit 135H), version 2 (implemented with qubit 135K and qubit 135H) or proposed version 3 (implemented with qubit 135L and qubit 135H)). For example, the client may determine that they want proposed version 3 of the quantum file 137 to be the authoritative version and that they do not want the changes made by the first entity (version 2 ) to take effect. Thus, the QVC service 138 may discard qubits 135J and 135K and generate version 3 of the quantum file 137, where the version 3 of the quantum file 137 references qubit 135L (which includes the changes to qubit 135G proposed by the second entity's requested work) and qubit 135H.

Alternatively, the client may determine that all three versions of the quantum file 137 should be preserved (i.e., all of the resolution pathways are valid). If the client determines that all three versions of the quantum file 137 should be preserved, the QVC service 138 may maintain its lock on the qubits 135J, 135K and 135L and generate version 3 of the quantum file 137 that references qubits 135L (which includes the changes proposed by the second entity's work) and 135H. In this way, if the first entity subsequently returns and wants to continue their work, when presented with the version conflict file 139 they can create their version of the quantum file 137 (version 2 in this case) in an ad hoc manner by selecting the resolution pathway including qubit 135K and qubit 135H.

The use of biasing also allows the client to generate new variants of the quantum file 137 that can accommodate changes from multiple versions by algorithmically influencing the superposition result. Thus, the client may also generate a new version of the quantum file 137 that includes changes from multiple versions of the quantum file 137 and identify the new version of the quantum file 137 as the authoritative version.

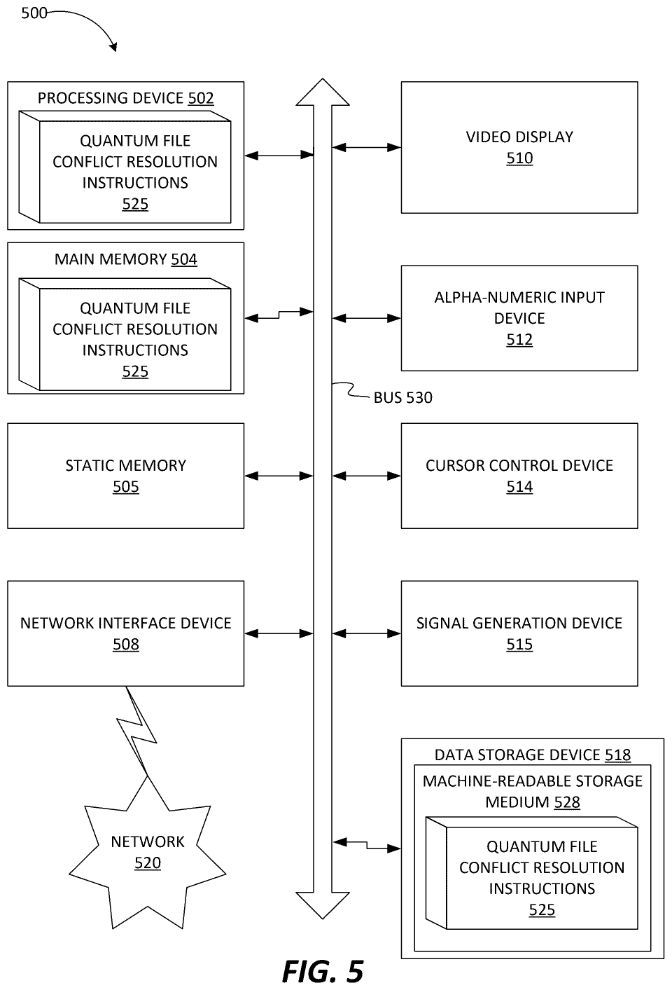

FIG. 5 illustrates a diagrammatic representation of a machine in the example form of a computer system 500 within which a set of instructions, for causing the machine to perform any one or more of the methodologies discussed herein for resolving conflicts in quantum files.

In alternative embodiments, the computer system 500 may be connected (e.g., networked) to other machines in a local area network (LAN), an intranet, an extranet, or the Internet. The computer system 500 may operate in the capacity of a server or a client machine in a client-server network environment, or as a peer machine in a peer-to-peer (or distributed) network environment. The computer system 500 may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single computer system is illustrated, the terms “computer system” and “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 430. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute quantum file conflict resolution instructions 525, for performing the operations and steps discussed herein.

The data storage device 518 may include a machine-readable storage medium 528, on which is stored one or more sets of quantum file conflict resolution instructions 525 (e.g., software) embodying any one or more of the methodologies of functions described herein. The quantum file conflict resolution instructions 525 may also reside, completely or at least partially, within the main memory 504 or within the processing device 502 during execution thereof by the computer system 500; the main memory 504 and the processing device 502 also constituting machine-readable storage media. The quantum file conflict resolution instructions 525 may further be transmitted or received over a network 520 via the network interface device 508.

The machine-readable storage medium 528 may also be used to store instructions to perform a method for resolving conflicts in quantum files, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “modifying,” “storing,” “allocating,” “generating,” “returning,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed.

Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
modifying, by a first entity, a first qubit having original data associated with a first version of a quantum file, wherein the first qubit stores first modified data associated with a second version of the quantum file in response to the modifying;
in response to receiving a request from a second entity to modify the first qubit with second modified data associated with a proposed third version of the quantum file, allocating a set of auxiliary qubits;
storing the original data, the first modified data and the second modified data in a first auxiliary qubit, a second auxiliary qubit and a third auxiliary qubit of the set of auxiliary qubits respectively;
generating a version conflict file that references each of the first auxiliary qubit, the second auxiliary qubit and the third auxiliary qubit; and
in response to receiving a request to access a current version of the quantum file, returning the version conflict file.

2. The method of claim 1, further comprising:
placing the first auxiliary qubit, the second auxiliary qubit and the third auxiliary qubit into superposition to enable selection of a version of the quantum file to access.

3. The method of claim 2, further comprising:
selecting a version of the quantum file to access by biasing one of the first auxiliary qubit, the second auxiliary qubit or the third auxiliary qubit based on whether the first version of the quantum file, the second version of the quantum file or the proposed third version of the quantum file is desired.

4. The method of claim 2, wherein selecting the version of the quantum file comprises using biasing to generate a new version of the quantum file that is based on one or more of the first version of the quantum file, the second version of the quantum file or the proposed third version of the quantum file.

5. The method of claim 1, further comprising:
identifying the proposed third version of the quantum file as an authoritative version of the quantum file;
discarding the first auxiliary qubit and the second auxiliary qubit; and
generating a third version of the quantum file that references the third auxiliary qubit.

6. The method of claim 1, further comprising:
generating a record for the version conflict file; and
inserting the record into a quantum file registry.

7. The method of claim 1, wherein each of the set of auxiliary qubits is empty when it is allocated.

8. A system comprising:
a memory; and
a processing device operatively coupled to the memory, the processing device to:
modify, by a first entity, a first qubit having original data associated with a first version of a quantum file, wherein the first qubit stores first modified data associated with a second version of the quantum file in response to the modifying;
in response to receiving a request from a second entity to modify the first qubit with second modified data associated with a proposed third version of the quantum file, allocate a set of auxiliary qubits;
store the original data, the first modified data and the second modified data in a first auxiliary qubit, a second auxiliary qubit and a third auxiliary qubit of the set of auxiliary qubits respectively;
generate a version conflict file that references each of the first auxiliary qubit, the second auxiliary qubit and the third auxiliary qubit; and
in response to receiving a request to access a current version of the quantum file, return the version conflict file.

9. The system of claim 8, wherein the processing device is further to:
place the first auxiliary qubit, the second auxiliary qubit and the third auxiliary qubit into superposition to enable selection of a version of the quantum file to access.

10. The system of claim 9, wherein the processing device is further to:
select a version of the quantum file to access by biasing one of the first auxiliary qubit, the second auxiliary qubit or the third auxiliary qubit based on whether the first version of the quantum file, the second version of the quantum file or the proposed third version of the quantum file is desired.

11. The system of claim 9, wherein to select the version of the quantum file, the processing device is to use biasing to generate a new version of the quantum file that is based on one or more of the first version of the quantum file, the second version of the quantum file or the proposed third version of the quantum file.

12. The system of claim 8, wherein the processing device is further to:
identify the proposed third version of the quantum file as an authoritative version of the quantum file;
discard the first auxiliary qubit and the second auxiliary qubit; and
generate a third version of the quantum file that references the third auxiliary qubit.

13. The system of claim 8, wherein the processing device is further to:
generate a record for the version conflict file; and
insert the record into a quantum file registry.

14. The system of claim 8, wherein each of the set of auxiliary qubits is empty when it is allocated.

15. A non-transitory computer-readable medium having instructions stored thereon which, when executed by a processing device, cause the processing device to:
modify, by a first entity, a first qubit having original data associated with a first version of a quantum file, wherein the first qubit stores first modified data associated with a second version of the quantum file in response to the modifying;
in response to receiving a request from a second entity to modify the first qubit with second modified data associated with a proposed third version of the quantum file, allocate a set of auxiliary qubits;
store the original data, the first modified data and the second modified data in a first auxiliary qubit, a second auxiliary qubit and a third auxiliary qubit of the set of auxiliary qubits respectively;
generate a version conflict file that references each of the first auxiliary qubit, the second auxiliary qubit and the third auxiliary qubit; and
in response to receiving a request to access a current version of the quantum file, return the version conflict file.

16. The non-transitory computer-readable medium of claim 15, wherein the processing device is further to:
place the first auxiliary qubit, the second auxiliary qubit and the third auxiliary qubit into superposition to enable selection of a version of the quantum file to access.

17. The non-transitory computer-readable medium of claim 16, wherein the processing device is further to:
select a version of the quantum file to access by biasing one of the first auxiliary qubit, the second auxiliary qubit or the third auxiliary qubit based on whether the first version of the quantum file, the second version of the quantum file or the proposed third version of the quantum file is desired.

18. The non-transitory computer-readable medium of claim 16, wherein to select the version of the quantum file, the processing device is to use biasing to generate a new version of the quantum file that is based on one or more of the first version of the quantum file, the second version of the quantum file or the proposed third version of the quantum file.

19. The non-transitory computer-readable medium of claim 15, wherein the processing device is further to:
identify the proposed third version of the quantum file as an authoritative version of the quantum file;
discard the first auxiliary qubit and the second auxiliary qubit; and
generate a third version of the quantum file that references the third auxiliary qubit.

20. The non-transitory computer-readable medium of claim 15, wherein the processing device is further to:
generate a record for the version conflict file; and
insert the record into a quantum file registry.
